(19) United States
(12) Patent Application Publication
(10) Pub. No.: US 2016/0047397 A1
(43) Pub. Date: Feb. 18, 2016

(54) HYDRAULIC HYBRID SYSTEMS, COMPONENTS, AND CONFIGURATIONS

(71) Applicant: Stored Energy Solutions Inc., Indianapolis, IN (US)

(72) Inventors: Robert James Sikorski, Stow, OH (US); Ren Levi Copeland, Greenfield, IN (US)

(21) Appl. No.: 14/921,913

(22) Filed: Oct. 23, 2015

Related U.S. Application Data
(63) Continuation-in-part of application No. 14/215,860, filed on Mar. 17, 2014.
(60) Provisional application No. 61/788,774, filed on Mar. 15, 2013.
(60) Provisional application No. 62/067,967, filed on Oct. 23, 2014.

(51) Int. Cl. F15B 1/02; F15B 1/027; F15B 13/02; F15B 1/04

(52) U.S. Cl. CPC F15B 1/024; F15B 1/04; F15B 1/027; F15B 13/027; F15B 2201/00

(57) ABSTRACT

An example embodiment includes a hydraulic hybrid system. The hydraulic hybrid system includes a hydraulic system, an energy source configured to produce primary kinetic energy, an output configured to receive at least a first portion of the primary kinetic energy, and a transmission coupled between the energy source and the output and selectively coupled to the hydraulic system. The hydraulic system includes a reservoir, a sequenced accumulator assembly, and a hydraulic pump/motor that is hydraulically coupled to the reservoir and the sequenced accumulator assembly and configured to charge the sequenced accumulator assembly when mechanically driven. The sequenced accumulator assembly includes two or more accumulators, one or more sequence valves, and one or more check valves. The sequenced accumulator assembly is configured to store varying amounts of potential hydraulic energy by introducing and removing one or more of the accumulators from operation.

### CROSS REFERENCE TO RELATED APPLICATIONS

This patent application claims priority to and the benefit of U.S. patent application Ser. No. 14/215,860 filed Mar. 17, 2014, which claims priority to U.S. Provisional Patent Application No. 61/788,774, filed Mar. 15, 2013. This patent application also claims priority to and the benefit of U.S. Provisional Patent Application No. 62/067,967 filed Oct. 23, 2014. The disclosures of these applications are incorporated herein by reference in their entireties.

### FIELD

The embodiments discussed herein are related to hybrid systems. In particular, some embodiments relate to hydraulic hybrid systems.

### BACKGROUND

Hybrid systems generally relate to the inclusion of two technologies to increase the overall efficiency of a system. An example hybrid system is a gasoline/electric hybrid vehicle. In the gasoline/electric hybrid vehicle an electrical motor operates in tandem with a fossil fuel engine. The electrical motor and the fossil fuel engine cooperate to generate energy to move the hybrid vehicle. Hydraulic hybrid systems incorporate a hydraulic system with another technology (usually a fossil fuel engine or a motor) to increase the efficiency of a system including both. For example, a fossil fuel engine may store potential energy in a hydraulic accumulator. The potential energy may be recouped later by discharging the hydraulic accumulator to provide kinetic energy to the system.

The subject matter claimed herein is not limited to embodiments that solve any disadvantages or that operate only in environments such as those described above. Rather, this background is only provided to illustrate one example technology area where some embodiments described herein may be practiced.

### SUMMARY

An example embodiment includes a hydraulic hybrid system. The hydraulic hybrid system includes a hydraulic system, an energy source configured to produce primary kinetic energy, an output configured to receive at least a first portion of the primary kinetic energy, and a transmission coupled between the energy source and the output and selectively coupled to the hydraulic system. The hydraulic system includes a reservoir, a sequenced accumulator assembly, a hydraulic pump/motor, a reverse free flow check valve, a dump valve, and a sequence valve. The sequenced accumulator assembly includes a first accumulator, a second accumulator, and a third accumulator. The hydraulic pump/motor is hydraulically coupled to the reservoir and the sequenced accumulator assembly and configured to charge the sequenced accumulator assembly when mechanically driven. The sequence valve is configured to sequentially fill the second accumulator and the third accumulator as pressure in the first accumulator increases and configured to sequence the filling of the second accumulator and the third accumulator smoothly.

An example embodiment includes a hydraulic hybrid system. The hydraulic hybrid system includes a hydraulic system, an energy source configured to produce primary kinetic energy, an output configured to receive at least a first portion of the primary kinetic energy, and a transmission coupled between the energy source and the output and selectively coupled to the hydraulic system. The hydraulic system includes a reservoir, a sequenced accumulator assembly, and a hydraulic pump/motor that is hydraulically coupled to the reservoir and the sequenced accumulator assembly and configured to charge the sequenced accumulator assembly when mechanically driven. The sequenced accumulator assembly includes two or more accumulators, one or more sequence valves, and one or more check valves. The sequenced accumulator assembly is configured to store varying amounts of potential hydraulic energy by introducing and removing one or more of the accumulators from operation.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a block diagram of an example hydraulic hybrid system;

FIG. 2 illustrates a block diagram of an example sequenced accumulator assembly that may be implemented in the hydraulic hybrid system of FIG. 1;

FIG. 3 illustrates a block diagram of an example accumulator assembly that may be implemented in the hydraulic hybrid system of FIG. 1; and

FIG. 4 illustrates an example embodiment of a portion of the hydraulic system of FIG. 1,

all arranged in accordance with at least one embodiment described herein.

### DESCRIPTION OF SOME EXAMPLE EMBODIMENTS

Some existing hydraulic hybrid systems are limited in applicability due to inefficiencies associated with storage of potential energy. Specifically, some hydraulic hybrid vehicles may include one or more accumulators with fixed volumes. Depending on the operating characteristics of the hydraulic hybrid vehicle, the fixed volumes may ineffectively receive and store potential energy causing losses in overall efficiency of the system. For example, when a hydraulic hybrid vehicle is travelling at a speed below some threshold, a pressure received by the hydraulic accumulators may not sufficiently build a usable potential energy. However, at a second speed above the threshold the hydraulic accumulator may charge. Thus, potential energy stored in the hydraulic accumulator may only be recouped when the hydraulic hybrid vehicle is operating within a subset of operating conditions, leading to inefficient energy storage.

An example embodiment includes a regenerative hydraulic circuit. The regenerative hydraulic circuit is configured to capture kinetic energy from a machine and store the kinetic energy as hydraulic potential energy in an accumulator having a variable-volume. When the kinetic output of the machine is low, a storage volume of the accumulator may be decreased resulting in adequate predetermined system pressure for when the vehicle is stopped. The storage volume may be adjusted through control of a fluid into a control volume of the accumulator. The control of the fluid may be volumetrically dependent on the kinetic output of the machine. As the kinetic output of the machine increases, the storage volume of the accumulator increases to capture an increased kinetic energy. The storage volume is configured to vary infinitely within the overall kinetic output range of the machine. Some additional embodiments are explained with reference to the accompanying drawings.

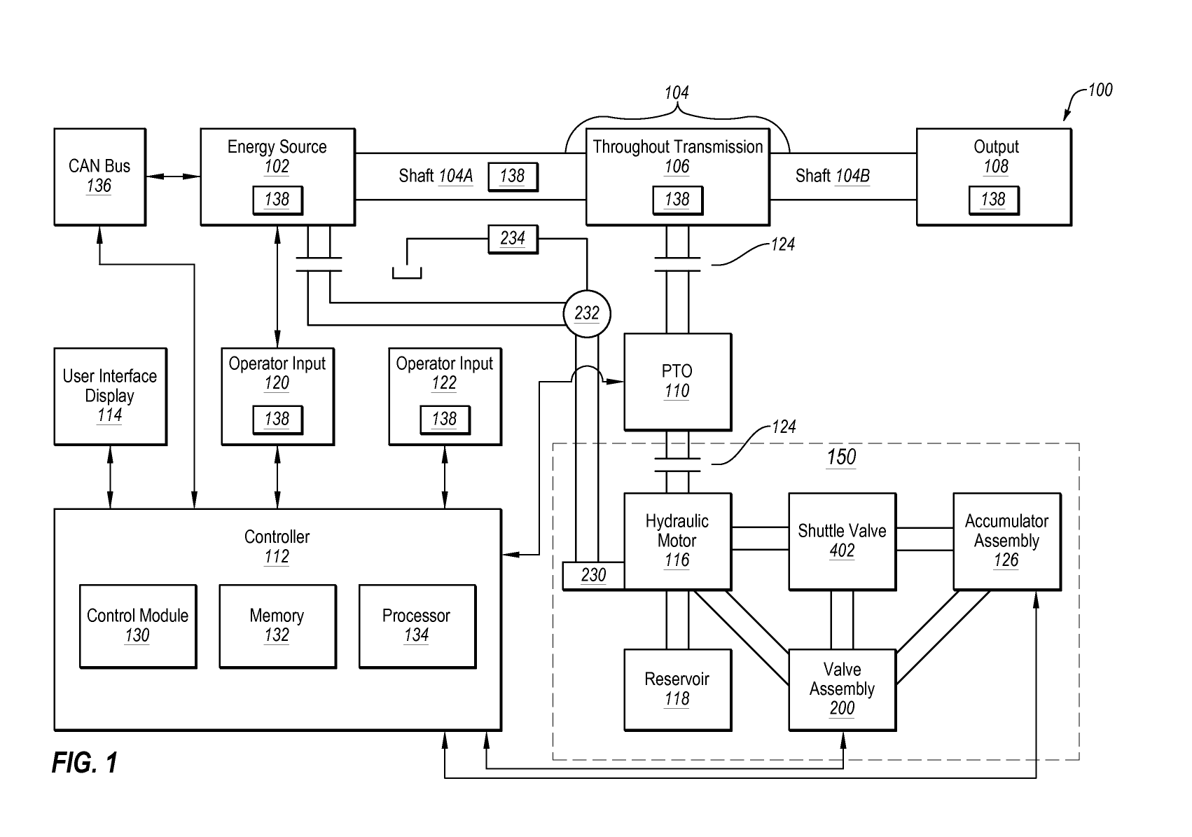

FIG. 1 illustrates a block diagram of an example hydraulic hybrid system 100. The hydraulic hybrid system 100 is generally a regenerative hydraulic system. The hydraulic hybrid system 100 enables capture of kinetic energy that may be otherwise wasted, stores the energy as hydraulic potential energy, and then enables discharge of the hydraulic potential energy to the hydraulic hybrid system 100. In the depicted embodiment, the hydraulic hybrid system 100 captures rotational energy and discharges the hydraulic potential energy as auxiliary or supplementary rotational energy. The hydraulic hybrid system 100 and/or principles discussed with reference to the hydraulic hybrid system 100 may be implemented to capture, store, and discharge energy in other systems such as lifting and/or translating systems.

The hydraulic hybrid system 100 includes an energy source 102 that may be configured to produce a primary kinetic energy, a portion of which is transferred to an output 108. Some examples of the energy source 102 may include a hydraulic pump/motor, a gasoline engine, a diesel engine, a steam engine, an electric motor, a turbine engine, or any other mechanized system that provides, directly or indirectly, kinetic energy to the output 108. In some embodiments, the energy source 102 may include an automotive engine and transmission. The output 108 may include any apparatus that receives the primary kinetic energy of a shaft 104 and performs some function. For example, the output 108 may include a differential of a vehicle.

The energy source 102 is coupled with a hydraulic system 150. The hydraulic system 150 is configured to capture some of the rotational energy of the shaft 104 and store the rotational energy as hydraulic potential energy in an accumulator assembly 126. The accumulator assembly 126 may have a variable storage volume. By varying the storage volume of the accumulator assembly 126, the hydraulic hybrid system 100 may capture a larger range of the energy available at the shaft 104. Additionally, by varying the volume of the accumulator assembly 126, the hydraulic system 150 may efficiently discharge the energy back to the hydraulic hybrid system 100. For instance, when available primary kinetic energy or demand is low, the storage volume of the accumulator assembly 126 may be reduced to meet the specific need. When the available primary kinetic energy or demand is high, the storage volume of the accumulator assembly 126 may be increased to meet the specific need. In some embodiments, the storage volume may depend on operational conditions of the energy source 102, the output 108, a machine including the energy source 102 and the hydraulic system 150, or some combination thereof. For example, the storage volume may be dependent on ground speed, rotational speed of the shaft 104, and the like.

The hydraulic system 150 is further configured to release the hydraulic potential energy and apply an auxiliary or supplementary rotational energy to the shaft 104 under certain operating conditions of the energy source 102 and/or under certain operating conditions of the output 108.

Between the energy source 102 and the output 108, the shaft 104 may be coupled to a throughput transmission 106. In some embodiments, a first shaft section 104A is decoupled from a second shaft section 104B and the throughput transmission 106 is installed between the first shaft section 104A and the second shaft section 104B. In these and other embodiments, within the throughput transmission 106, the shaft 104 may continue as a solid shaft. For example, the solid shaft may include one or more universal joints with gearing to transfer rotation of the first shaft section 104A to the second shaft section 104B.

Some embodiments of the throughput transmission 106 may include a close coupling to the energy source 102. In these close coupling embodiments, the throughput transmission 106 is installed directly to the energy source 102, which may eliminate the first shaft section 104A. For example, the energy source 102 may include an engine and transmission of a vehicle. In this example, the throughput transmission 106 may be directly attached to the transmission or otherwise integrated with the transmission or the engine.

The throughput transmission 106 may include a power take off (PTO) 110 configured to selectively couple the shaft 104 to a hydraulic pump/motor (hydraulic motor) 116. The hydraulic motor 116 can be mounted in line with the shaft 104, in tandem with the shaft 104, in parallel with the shaft 104, or in series with the shaft 104 depending on a configuration of the PTO 110 and/or the throughput transmission 106.

Additionally, in the embodiment of FIG. 1, a clutch 124 or a splined unit (not shown) may selectively couple the shaft 104 to the hydraulic motor 116 via the PTO 110. The clutch 124 can be engaged and disengaged to reduce torque load on the shaft 104 and/or the hydraulic motor 116, for instance. Some examples of the clutch 124 may include a direct face mount clutch or a cylindrical clutch that at least partially encapsulates a rotating group (e.g., some portions of the PTO 110 and some portions of the hydraulic motor 116). In some embodiments, the clutch 124 may be configured to engage when the energy source 102 is stopped and to disengage when the energy source 102 is operating at speed. The clutch 124 (or the splined unit) can be engaged and disengaged pneumatically, hydraulically, electrically, or mechanically. Additionally or alternatively, the clutch 124 (or the splined unit) may be controlled by a controller 112. Some details of the controller 112 are provided elsewhere herein.

For example, when the shaft 104 is rotating and/or the energy source 102 is generally operating at a steady state, the clutch 124 may be disengaged. Thus, the rotation of the shaft 104 is applied to the output 108. However, when a second operator input 122 such as a brake is applied to the energy source 102, the clutch 124 may be engaged, enabling the shaft 104 to transfer rotational energy through the PTO 110 and to the hydraulic motor 116. Likewise, when a first operator input 120 such as an accelerator is applied to the energy source 102, the clutch 124 may mechanically couple the hydraulic motor 116 to the shaft 104 via the PTO 110, which may enable the hydraulic motor 116 to drive the shaft 104 by itself or in combination with the energy source 102.

In some embodiments, the hydraulic hybrid system 100 may omit the PTO 110. In these and other embodiments, the hydraulic motor 116 may be mounted in-line with the shaft 104 or integrated into the shaft 104. A hydraulic motor shaft (not shown) may be splined and another shaft that encompasses the hydraulic motor shaft may be oppositely splined. To drive the hydraulic motor 116, an actuator may slide a portion of the hydraulic motor 116 or the hydraulic motor shaft to engage splines or disengage splines.

The PTO 110, the throughput transmission 106, the hydraulic motor 116, or some combination thereof may be entirely disengaged from the shaft 104, which may enable the energy source 102 to operate apart from the hydraulic system 150. In some embodiments, the shaft 104 may be entirely disengaged from the hydraulic system 150 from a PTO clutch (not shown) configured to disengage the hydraulic motor 116. Enabling the energy source 102 to operate apart from the hydraulic system 150 may be useful during an operational failure of a component of the hydraulic system 150, for example. By entirely disengaging the PTO 110, the throughput transmission 106, the hydraulic motor 116, or some combination thereof, the energy source 102 may continue to operate.

The hydraulic motor 116 may be hydraulically coupled to a reservoir 118, a valve assembly 200, a shuttle valve 402, the accumulator assembly 126, or some combination thereof. The accumulator assembly 126, the valve assembly 200, and the shuttle valve 402 are depicted separate from the reservoir 118. In some embodiments, the accumulator assembly 126, the valve assembly 200, the shuttle valve 402, or some portions or combinations thereof may be located within the reservoir 118. Additionally, in FIG. 1, the valve assembly 200 is depicted separate from the shuttle valve 402. In some embodiments, the shuttle valve 402 may include one or more components of the valve assembly 200.

When the shaft 104 is transferring energy to the hydraulic motor 116, the valve assembly 200 is configured such that the hydraulic motor 116 is driving hydraulic fluid from the reservoir 118 to the accumulator assembly 126. The hydraulic fluid builds pressure in the accumulator assembly 126 and accordingly builds hydraulic potential energy. While the accumulator assembly 126 is discharging hydraulic potential energy to the hydraulic motor 116, the valve assembly 200 may be configured such that the hydraulic fluid (or another working fluid) is ported from the accumulator assembly 126 to the hydraulic motor 116, which may cause rotation of the hydraulic motor 116. The rotation of the hydraulic motor 116 may be transferred to the shaft 104 through the PTO 110.

In some embodiments, one or more components of the accumulator assembly 126 may be used as structural members. For example, in embodiments of the hydraulic hybrid system 100 that includes a vehicle, an accumulator included in the accumulator assembly 126 may be incorporated into a vehicle chassis.

The hydraulic motor 116 may include a variable-displacement motor, a constant displacement motor, a gear hydraulic pump, a gerotor pump, a vane pump, a piston pump, or any other suitable pump. Generally, a variable-displacement motor may vary the amount of hydraulic fluid that is moved in one cycle of the hydraulic motor 116. The amount of hydraulic fluid can be controlled remotely or directly. Additionally or alternatively, the amount of the hydraulic fluid can be controlled using a fluid, an electrical signal, or a mechanical actuator. By varying the amount of hydraulic fluid in one cycle of the hydraulic motor 116, a torque applied to the shaft 104 during discharge of the accumulator assembly 126 may be controlled. Thus, in these and other embodiments, a torque applied to the shaft 104 by discharge of the hydraulic potential energy may be controlled at least partially by the hydraulic motor 116.

The shuttle valve 402 may be included in the hydraulic system 150. The shuttle valve 402 is fluidly coupled to the hydraulic motor 116, the accumulator assembly 126, and the valve assembly 200. The shuttle valve 402 is configurable in a first configuration in which pressure is supplied to the valve assembly 200 from the hydraulic motor 116 and pressure is prevented from being supplied from the accumulator assembly 126. In addition, the shuttle valve 402 is configurable in a second configuration in which pressure is supplied to the valve assembly 200 from the accumulator assembly 126 and pressure is prevented from being supplied from the hydraulic motor 116.

The hydraulic hybrid system 100 may include the first operator input 120 and the second operator input 122, as discussed above. The first operator input 120 and the second operator input 122 may include, but are not limited to: foot pedals, levers, actuators, another control system providing electrical or mechanical input, etc. The first operator input 120 and the second operator input 122 are not necessarily of a common or similar type and may or may not be operated by a common operator.

The hydraulic hybrid system 100 may include the controller 112. In some embodiments, the controller 112 includes an electronic controller configured to operate through communication of electrical signals generated at the components and/or sensors monitoring operation of the components. In these and other embodiments, the controller 112 may interface with the energy source 102 via a controller area network (CAN) bus 136, which may enable communication of electrical signals from the components electrically coupled to the CAN bus 136. Additionally, the controller 112 may receive other signals via other communication interfaces, without limitation.

The controller 112 may receive data from one or more discrete feedback devices 138. The discrete feedback devices 138 may be retrofit onto the energy source 102, the shaft 104, the throughput transmission 106, the output 108, some combination thereof, or some features thereof. The discrete feedback devices 138 may be configured to indicate an operating condition of the hydraulic hybrid system 100. For instance, one or more of the discrete feedback devices 138 may indicate a position of a component (e.g., 120 or 122), a change in position of the component, a rate of change of the component, etc. The operating conditions of the hydraulic hybrid system 100 may be viewed and/or altered via a user interface display 114.

The discrete feedback devices 138 may include sensors and instruments mounted to or otherwise monitoring the components in which the discrete feedback devices 138 are included. The controller 112 may adjust one or more settings and/or operational states in the components of the hydraulic hybrid system 100 based on data measured by the discrete feedback devices 138. For example, the controller 112 may receive rotational data from a tachometer monitoring rotational speed of the shaft 104. A volume of an accumulator included in the accumulator assembly 126 may be adjusted based on the received rotational data. Some other examples of the discrete feedback devices 138 may include pressure transducers, displacement sensors, system enable switches, position sensors, global positioning system (GPS) sensors/receivers, speed sensors, other similar sensors, or any combination thereof.

Additionally or alternatively, the discrete feedback devices 138 may include levers, switches, and actuators. The physical action of the levers, switches, and actuators may indicate an operating condition of the energy source 102. For example, a limit switch may be mounted near the first operator input 120. When a user operates the first operator input 120, motion of the first operator input 120 may physically interfere with the limit switch indicating a given position of the first operator input 120. The levers, switches, and actuators may be mechanical, hydraulic, electric, pneumatic, etc.

In some embodiments, the controller 112 may use a standard communication protocol. In these and other embodiments, signals communicated from the discrete feedback devices 138 and/or signals accessed via the CAN bus 136 may be formatted according to the standard communication protocol. For example, the controller 112 may use the J1939 bus protocol. Accordingly, in this and other embodiments, the discrete feedback devices 138 such as the position sensors and/or the speed sensors may generate J1939 messages.

The controller 112 may include a control module 130, memory 132, and a processor 134. The processor 134 may include an arithmetic logic unit (ALU), a microprocessor, a general-purpose controller, or some other processor array to perform computations and software program analysis. The processor 134 may be coupled to a bus for communication with the memory 132 and/or the control module 130. The processor 134 generally processes data signals and may include various computing architectures including a complex instruction set computer (CISC) architecture, a reduced instruction set computer (RISC) architecture, or an architecture implementing a combination of instruction sets. Although FIG. 1 includes a single processor 134, multiple processors may be included in the controller 112. Other processors, operating systems, and physical configurations may be possible.

The memory 132 may be configured to store instructions and/or data that may be executed by the processor 134. The memory 132 may be coupled to the bus for communication with the other components. The instructions and/or data may include code for performing the techniques or methods described herein. The memory 132 may include a DRAM device, an SRAM device, flash memory, or some other memory device. In some embodiments, the memory 132 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

The control module 130 may be configured to enable coordination between one or more components (e.g., 102, 120, 122, 106, 110, 116, 200, and 126) of the hydraulic hybrid system 100. In some embodiments, the control module 130 may be configured to control the start and stop of the energy source 102. For example, in embodiments in which the energy source 102 includes an engine of a vehicle, in response to a period of idling or upon reception of input indicative of a stop, the control module 130 may determine that the vehicle is stopped. The control module 130 may accordingly turn off the engine (e.g., 102). When an operator begins to move the vehicle (e.g., reduces pressure on a brake or depresses an accelerator), the control module 130 may port energy stored in the accumulator assembly 126 to the energy source 102 to restart the energy source 102.

In some embodiments, an auxiliary hydraulic pump may be positioned to engage a fly wheel of the energy source 102 to restart the energy source 102. In some embodiments, the control module 130 may engage an electric starter. In some embodiments, the hydraulic motor 116 may roll the vehicle forward, creating compression and start the energy source 102.

In some embodiments, the start and stop of the energy source 102 may depend on a fluid level or pressure level in the accumulator assembly 126. For instance, if insufficient energy is stored in the accumulator assembly 126, the control module 130 may not turn-off the energy source 102.

Additionally, in some embodiments, the control module 130 may be configured to shift the throughput transmission 106. For example, in response to a period of idling or upon reception of input indicative of a stop, the control module 130 may determine that the vehicle is stopped. The control module 130 may shift the throughput transmission 106 to neutral. When an operator begins to move the vehicle (e.g., reduces pressure on a brake or depresses an accelerator), the control module 130 may shift the throughput transmission 106 to a drive gear.

Additionally, in some embodiments, the control module 130 may interface with the vehicle transmission control module. The transmission control module shift setting for “ECO” shift minimizes the time the transmission has the torque converter active. In general, the increased torque provided by the hydraulic system 150 may minimize or reduce the time the torque converter is engaged such as in “ECO” shift mode and may minimize or reduce the energy losses typically seen when the torque converter is activated. In addition, the control module 130 may provide input or assist in shifting control in the eco-shift configuration.

In some embodiments of the hydraulic hybrid system 100 one or more components may be manufactured using a 3-D printer or additive manufacturing (AM). Generally, a 3-D printer or AM generates a component by successively adding layers of material and fusing the layers. For example, a first layer may be heated via a laser to a successive layer added to the first layer. Structures are eventually formed through addition of multiple layers.

In the hydraulic hybrid system 100, accumulator manifolds, fluid control manifolds, integrated fluid control valves, ports, as well as other components, may be manufactured using a 3-D printer or AM. Manufacturing one or more of these components or others included in the hydraulic hybrid system 100 may enable optimized flow passages to be printed internal to manifolds; valves to be printed internal to manifolds (e.g., check valves, butterfly valves, shuttle valves, poppet style valves, spool valves, pressure relief valves, sequencing valves, and any other fluid control type valve included in the hydraulic hybrid system 100); optimized wall thickness around fluid passages to ensure manifolds meet pressure and port requirements; weight reduction of manifold by using a lattice structure between fluid passages; weight reduction of manifold by removing unneeded material; customized shaping to enable optimal orientation of valves and other components that interface with manifolds; multiple materials to be used including plastics, steel, aluminum, and other readily available materials; variable density may be used to increase material strength where needed; dampening chambers may be created that are internal to manifolds and may be incorporated by increasing or decreasing a passage cavity and controlling the passage shape to cancel the pulses that get transmitted via the fluid medium; and localized heat treatment through the printing process (e.g., heating via a laser that fuses the layers). These and other advantages of 3-D printing may be beneficial in other applications. For example, the other applications may include industrial processing applications, mobile applications, medical applications, food processing applications, and pneumatic applications.

Other functions of the control module 130 and details of the hydraulic hybrid system 100 may be as described in U.S. patent application Ser. No. 14/215,860, which is incorporated herein by reference in its entirety.

In some embodiments, the hydraulic motor 116 may include a swash plate 230. An angle (stroke position) of the swash plate 230 may determine rotational characteristics of the hydraulic motor 116. The swash plate 230 may be controlled by servo pressure from an internal or external servo control pump that may be directly coupled to the hydraulic motor 116. In these embodiments, the servo control pump draws its hydraulic pressure from the hydraulic motor 116. Accordingly, when the swash plate 230 is controlled by the coupled servo control pump, there may be a delay (e.g., until servo pressure increases) before the angle of the swash plate 230 may be changed.

In the embodiment of FIG. 1, a control servo pump (servo pump) 232 may be included that ports pressure to the swash plate 230 or other components of the hydraulic system 150. The servo pump 232 may be driven by the energy source 102 or an auxiliary system of the energy source 102. For example, the servo pump 232 may be belt driven and introduced into or driven from a power steering pump, AC compressor, alternator, or the like. Additionally, the servo pump 232 may interface through a transmission PTO, an Engine PTO, or any other suitable driving mechanism.

Inclusion of the servo pump 232 may improve responsiveness of the hydraulic motor 116 and accordingly the hydraulic system 150. In particular, the servo pump 232 may enable anticipation of motion. For example, when a vehicle is stopped, a next operating condition is likely to be acceleration. The energy source 102, which may include an engine may be operational when the vehicle is stopped, thus the servo pump 232 may have servo pressure sufficient to change the angle of the swash plate 230. Thus, a control system may anticipate the acceleration of the vehicle and port pressure to the swash plate 230 to position it for the acceleration (e.g., driving the shaft 104).

In some embodiments, the servo pump 232 may include an unloading valve 234. The unloading valve 234 may allow for free spin of the servo pump 232 when it is not being used and may be controlled to change position when the servo pump 232 is going to be used. The unloading valve 234 may be electrically controlled (e.g., solenoid, etc.).

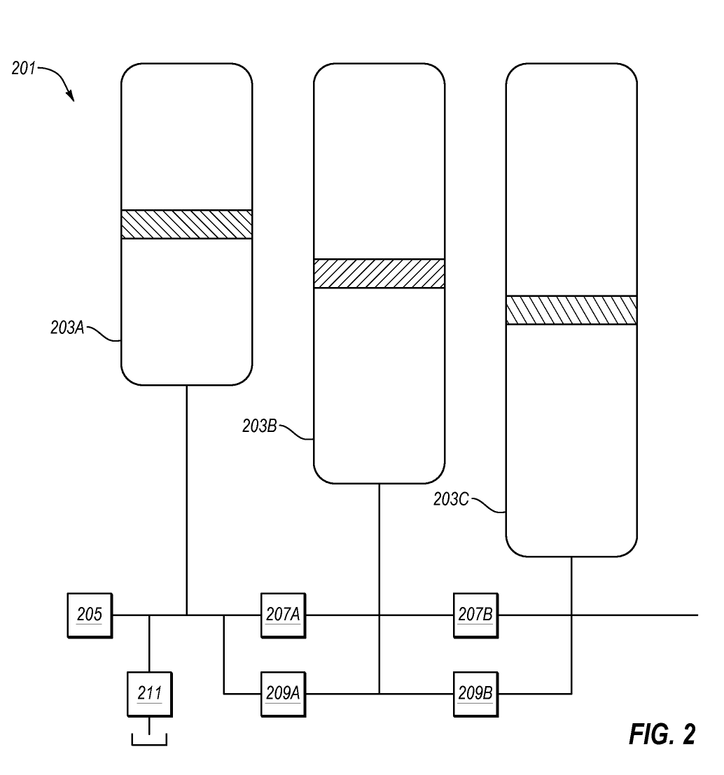

FIG. 2 illustrates a block diagram of an example sequenced accumulator assembly 201 that may be implemented in the hydraulic hybrid system 100 of FIG. 1 or another suitable system. For instance, the sequenced accumulator assembly 201 may be implemented in the accumulator assembly 126 of FIG. 1. The sequenced accumulator assembly 201 includes accumulators 203A-203C (generally, accumulator 203 or accumulators 203) configured to store varying amounts of potential hydraulic energy, or more generally, the sequenced accumulator assembly 201 may include two or more accumulators 203. In the sequence accumulator assembly 201, rather than adjusting the volume of a chamber as in a variable-volume accumulator, the sequenced accumulator assembly 201 varies volume and/or pressure by introducing and removing the accumulators 203 from operation. For example, in the sequenced accumulator assembly 201, the accumulators 203 may be individually hydraulically isolated, which may reduce volume and may be individually hydraulically coupled, which may increase volume.

In the sequenced accumulator assembly 201, the accumulators 203 may be connected in a serial configuration or in a parallel configuration. Additionally or alternatively, one or more of the accumulators 203 may have different or the same volumes.

In FIG. 2, the accumulators 203 are configured in a series configuration and the accumulators 203 have different volumes. In some embodiments, the accumulators 203 may have the same volume, may be configured in parallel, may act in parallel, or some combination thereof. The accumulators 203 may be separated by primary valves 207A and 207B with secondary valves 209A and 209B configured in parallel to the primary valves 207A and 207B. Operation of the primary valves 207A and 207B and the secondary valves 209A and 209B may introduce and remove one or more of the accumulators 203 to a system 205. The primary valves 207A and 207B and the secondary valves 209A and 209B may be controlled by operating conditions of the system 205, feedback from the system 205, conditions in the accumulators 203, or some combination thereof.

In some embodiments, the primary valves 207A and 207B may be sequence valves and the secondary valves may be check valves. In some alternative embodiments, one or more of the primary valves 207A and 207B and/or one or more of the secondary valves 209A and 209B may include directional valves, counterbalance valves, shuttle valves, orifices, or relief valves. Additionally or alternatively, one or more of the secondary valves 209A and 209B may be omitted.

The accumulators 203 may be charged in a charge sequence and/or discharged in a discharge sequence (collectively, sequence or sequences). The sequence may be controlled by the primary valves 207A and 207B (as in FIG. 2) or pressures at one or more of the primary valves 207A and/or 207B. For example, a first accumulator 203A may be charged to a first particular pressure, then a second accumulator 203B may be charged at the first particular pressure. Accordingly, the pressure at the system 205 may be held substantially constant. By including the second accumulator 203B, the storage volume of the sequenced accumulator assembly 201 increases. Accordingly, to include the second accumulator 203B the operating conditions may be sufficient to fill the first accumulator 203A and at least partially fill the second accumulator 203B.

Additionally, the first accumulator 203A may be discharged. When pressure is reduced and the equilibrium between the first and the second accumulators 203A and 203B is reached, both accumulators 203 may discharge simultaneously. In some embodiments, the first accumulator 203A is discharged to a particular pressure in the second accumulator 203B. The first accumulator 203A and the second accumulator 203B are then discharged together. Again, to include the first accumulator 203A, the operating conditions may be sufficient to warrant discharge of the potential energy stored in the first and second accumulators 203A and 203B. Sequentially charging and discharging the accumulators 203 may maximize power density of the energy stored in the accumulators 203, which may optimize regenerative properties of the sequenced accumulator assembly 201.

The accumulators 203 may be sized according to one or more characteristics of a system implementing the sequenced accumulator assembly 201. Specifically, with combined reference to FIGS. 1 and 2, in the hydraulic hybrid system 100, the accumulators 203 may be sized according to a total displacement of the hydraulic motor 116, according to a capacity of the hydraulic system 150, in relation to a particular revolution per min (RPM) rating and a drive ratio necessary to achieve a maximum pressure of the hydraulic system 150, but allowing maximum torque available at various increasing RPMs, or according to one or more of the factors listed above.

For example, the first accumulator 203A may be sized to achieve maximum charge at a first RPM. The second accumulator 203B may be sized so that a combined volume of the first accumulator 203A and the second accumulator 203B is about equal to a maximum charge at a second RPM, which is greater than the first RPM.

In some embodiments, two or more of the accumulators 203 may be connected through a common header or an integrated manifold. Integration of the two or more accumulators 203 connected through the common head or the integrated manifold may provide improved controls of pressures and volumes in the accumulators 203 over accumulators not connected through the common head or the integrated manifold. Additionally, the two or more of the accumulators 203 connected through the common head may reduce plumbing in a hydraulic system including the accumulators 203 connected through the common head. The two or more of the accumulators 203 connected through the common head may also reduce packaging requirements and reduce the amount of fittings and hoses used to plumb the accumulators 203.

The valve 211 may be configured to relieve of one or more of the accumulators 203 to a reservoir. For instance, the valve 211 may be configured as an over-pressure relief valve in some embodiments.

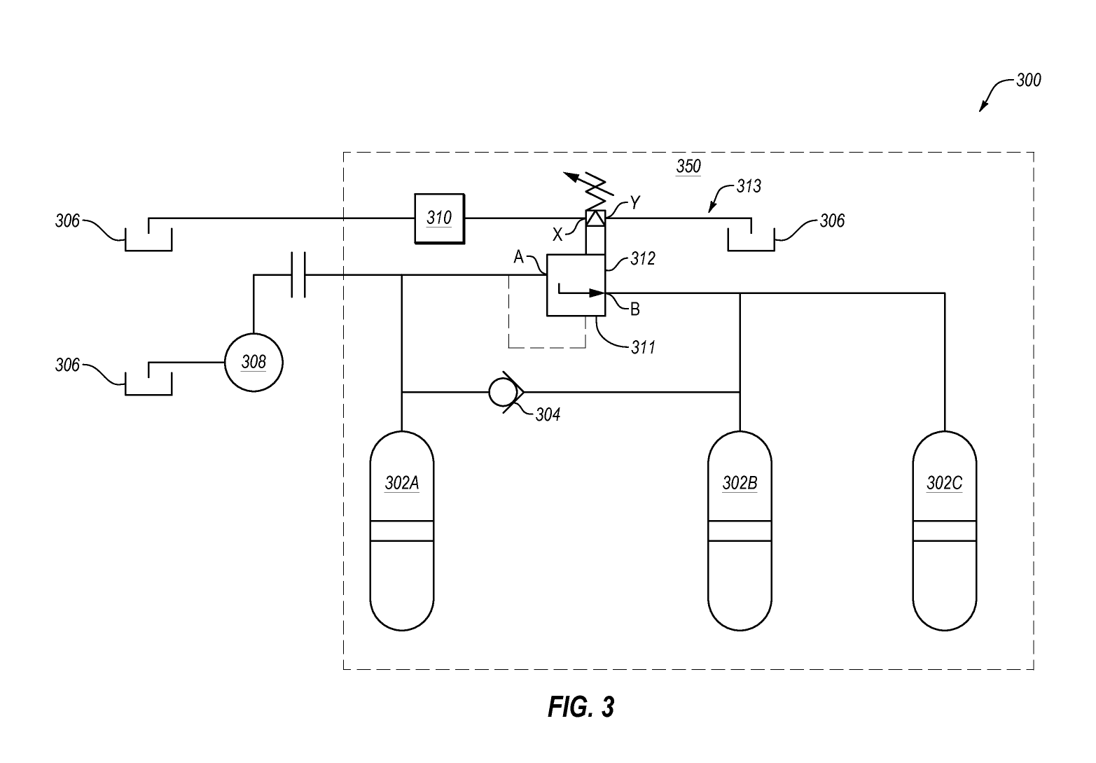

FIG. 3 illustrates a block diagram of an example accumulator assembly 350 that may be implemented in the hydraulic hybrid system 100 of FIG. 1. In the embodiment of FIG. 3, the accumulator assembly 350 may be configured as a sequence circuit. The sequence circuit may be implemented between accumulators in the hydraulic hybrid systems 100 of FIG. 1 as well as any other suitable application. For example, the accumulator assembly 350 may be an example of the accumulator assembly 126 described elsewhere in this disclosure. Additionally or alternatively, the accumulator assembly 350 of FIG. 3 may be an example of the sequenced accumulator assembly 201 of FIG. 2.

In FIG. 3, a throttle sequence valve (sequence valve) 312 is implemented in a portion of an example hydraulic system 300. The hydraulic system 300 may represent a portion of the hydraulic system 150 of FIG. 1 in some embodiments and/or include components described with reference to the hydraulic system 150 of FIG. 1.

The hydraulic system 300 includes a reservoir 306, a hydraulic pump 308, three accumulators 302A-302C (generally, accumulator 302 or accumulators 302), a dump valve 310, a reverse free flow check valve 304, and the sequence valve 312.

The reservoir 306 may be substantially similar to the reservoir 118, a hydraulic pump 308 may be substantially similar to the hydraulic motor 116, and the three accumulators 302 may be substantially similar to the accumulators 203 of FIG. 2.

The sequence valve 312 is configured to sequentially fill a second accumulator 302B and a third accumulator 302C as pressure in a first accumulator 302A increases. Additionally, the sequence valve 312 is configured to sequence the filling of the second accumulator 302B and the third accumulator 302C smoothly, such that the second accumulator 302B and the third accumulator 302C fill with little or no valve vibration.

The sequence valve 312 may include a first port (labeled ‘A’ in FIG. 3), a second port (labeled ‘B’ in FIG. 3), a vent (labeled ‘Y’ in FIG. 3), and a bypass port (labeled ‘X’ in FIG. 3). The first port is fluidly coupled to the hydraulic pump 308, to the first accumulator 302A, and to the reverse free flow check valve 304. Accordingly, as the hydraulic pump 308 is mechanically driven, pressure builds at the first port which in turn builds pressure in the first accumulator 302A. The second port is fluidly coupled to the second accumulator 302B and the third accumulator 302C and to the reverse free flow check valve 304.

In operation, the hydraulic pump 308 pumps fluid from the reservoir 306 and builds pressure in the first accumulator 302A and at the first port of the sequence valve 312. As pressure builds at the first port, the pressure in the first accumulator 302A builds. As pressure at the first port increases above a particular pressure, some of the pressure is piloted to a valve bottom 311 of the sequence valve 312, which begins to open the sequence valve 312. As the sequence valve 312 opens, the pressure at the first port that is above the particular pressure passes through the sequence valve 312 and fills the second and the third accumulators 302B and 302C. The sequence valve 312 includes internal porting that allows the throttling between the first port and a second port to be stable.

The vent of the sequence valve 312 enables the particular pressure at the first port to be set. Accordingly, a pressure at the first port may be held substantially constant regardless of the pressure at the second port. The vent is separated from the second port and vents to the reservoir 306.

The sequence valve 312 may be implemented as described with reference to FIG. 3 and/or implemented elsewhere in the hydraulic hybrid system 100 of FIG. 1 or the sequenced accumulator assembly 201 of FIG. 2.

The reverse free flow check valve 304 may be positioned between the first accumulator 302A and the second and third accumulators 302B and 302C. When pressures in the second and third accumulators 302B and 302C are substantially equal to or greater than a pressure in the first accumulator 302A, the reverse free flow check valve 304 opens which allows pressure to flow between the second and third accumulators 302B and 302C and the first accumulator 302A.

The dump valve 310 may be positioned between the bypass port and the reservoir 306. The dump valve 310 may be a shut-off valve that is electrically controlled in some embodiments. When the dump valve 310 is open, it dumps pressure on a pilot side 313 of the sequence valve 312. Thus, pressure at the first port passes through the sequence valve 312 without a throttling or sequence operation. Accordingly, the dump valve 310 is configured to disable the charge sequence. For example, an embodiment implemented in a hydraulic hybrid system of a vehicle, the dump valve 310 may be opened when the vehicle is operating at a high rate of speed. This may charge the accumulators 302 simultaneously or substantially simultaneously.

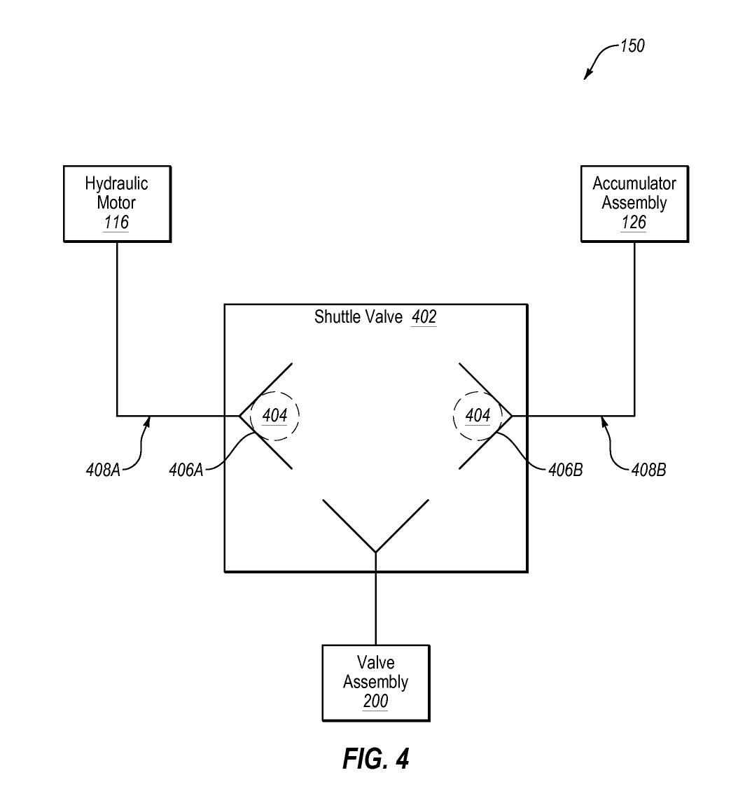

FIG. 4 illustrates an example embodiment of a portion of the hydraulic system 150 of FIG. 1 according to some embodiments. The portion depicted in FIG. 4 of the hydraulic system 150 may include the shuttle valve 402. The shuttle valve 402 may include two sources 408A and 408B, which include the hydraulic motor 116 and the accumulator assembly 126, respectively. The shuttle valve 402 may supply pressure provided by the sources 408A and 408B to the valve assembly 200.

For example, when system pressure in the hydraulic system 150 is high, which may be cause by rotation of the hydraulic motor 116, the shuttle valve 402 may be in a second configuration represented in FIG. 4 by ball 404 being in position 406B. In the second configuration, the pressure and fluid introduced into the shuttle valve 402 by the hydraulic motor 116 is ported to the valve assembly 200 and not to the accumulator assembly 126 via the shuttle valve 402.

Additionally, when system pressure in the hydraulic system 150 is low, which may be indicative of pressure in the accumulator assembly 126 being high, the shuttle valve 402 may be in a first configuration represented in FIG. 4 by ball 404 being in position 406A. In the first configuration, the pressure and fluid introduced into the shuttle valve 402 by the accumulator assembly 126 is ported to the valve assembly 200 and not to the hydraulic motor 116.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments.

The embodiments described herein may include the use of a special-purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general-purpose or special-purpose computer. By way of example, and not limitation, such computer-readable media may comprise non-transitory computer-readable storage media including RAM, ROM, EEPROM, CD-ROM or other optical disk storage, magnetic disk storage or other magnetic storage devices, or any other storage medium which may be used to carry or store desired program code in the form of computer-executable instructions or data structures and which may be accessed by a general-purpose or special-purpose computer. Combinations of the above may also be included within the scope of computer-readable media.

Computer-executable instructions comprise, for example, instructions and data which cause a general-purpose computer, special-purpose computer, or special-purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A hydraulic hybrid system comprising:
a hydraulic system;
an energy source configured to produce primary kinetic energy;
an output configured to receive at least a first portion of the primary kinetic energy; and
a transmission coupled between the energy source and the output and selectively coupled to the hydraulic system, wherein the hydraulic system includes:
a reservoir;
a sequenced accumulator assembly that includes a first accumulator, a second accumulator, and a third accumulator;
a hydraulic pump/motor that is hydraulically coupled to the reservoir and the sequenced accumulator assembly and configured to charge the sequenced accumulator assembly when mechanically driven;
a reverse free flow check valve;
a dump valve; and
a sequence valve, wherein the sequence valve is configured to sequentially fill the second accumulator and the third accumulator as pressure in the first accumulator increases and configured to sequence the filling of the second accumulator and the third accumulator smoothly.

2. The hydraulic hybrid system of claim 1, wherein the sequence valve includes:
a first port that is fluidly coupled to the hydraulic pump/motor, to the first accumulator such that as the hydraulic pump/motor is mechanically driven pressure builds at the first port, pressure in the first accumulator builds, and to the reverse free flow check valve; and
a second port that is fluidly coupled to the second accumulator and the third accumulator.

3. The hydraulic hybrid system of claim 2, wherein:
the sequence valve includes a valve bottom, wherein when pressure is ported to the valve bottom, the pressure opens the sequence valve; and
the sequence valve is configured such that as pressure at the first port increases above a particular pressure, a portion of the pressure is piloted to the valve bottom, which begins to open the sequence valve and as the sequence valve opens, the pressure at the first port above the particular pressure passes through the sequence valve, allows a working fluid to transfer from the first port to the second port, and fills the second and the third accumulators.

4. The hydraulic hybrid system of claim 3, wherein the sequence valve includes internal porting allows throttling between the first port and the second port to be stable.

5. The hydraulic hybrid system of claim 2, wherein the sequence valve includes a vent that enables a particular pressure at the first port to be set to the particular pressure and that allows the pressure at the first port and the first accumulator to be held substantially constant regardless of the pressure at the second port.

6. The hydraulic hybrid system of claim 5, wherein the vent is separated from the second port and vents to the reservoir.

7. The hydraulic hybrid system of claim 1, wherein the reverse free flow check valve is positioned between the first accumulator and the second and the third accumulators.

8. The hydraulic hybrid system of claim 7, wherein when pressures in the second and the third accumulators are substantially equal to or greater than a pressure in the first accumulator, the reverse free flow check valve opens which allows pressure to flow between the second and the third accumulators and the first accumulator.

9. The hydraulic hybrid system of claim 1, wherein the dump valve is a shut-off valve that is electrically controlled.

10. The hydraulic hybrid system of claim 9, wherein when the dump valve is open, it dumps pressure on a pilot side of the sequence valve such that the pressure at the first port passes through the sequence valve without a throttling or sequencing operation.

11. The hydraulic hybrid system of claim 10, wherein the dump valve is configured to disable the sequence valve by opening the sequence valve which charges the first accumulator, the second accumulator, and the third accumulator simultaneously.

12. A hydraulic hybrid system comprising:
a hydraulic system;
an energy source configured to produce primary kinetic energy;
an output configured to receive at least a first portion of the primary kinetic energy; and
a transmission coupled between the energy source and the output and selectively coupled to the hydraulic system,
wherein the hydraulic system includes:
a reservoir;
a sequenced accumulator assembly; and
a hydraulic pump/motor that is hydraulically coupled to the reservoir and the sequenced accumulator assembly and configured to charge the sequenced accumulator assembly when mechanically driven, wherein:
the sequenced accumulator assembly includes two or more accumulators, one or more sequence valves, and one or more check valves, and
the sequenced accumulator assembly is configured to store varying amounts of potential hydraulic energy by introducing and removing one or more of the accumulators from operation.

13. The hydraulic hybrid system of claim 12, wherein:
the sequenced accumulator assembly is charged in a charge sequence in which a first accumulator of the two or more accumulators is charged to a particular pressure, and then a second accumulator of the two or more accumulators is charged with a pressure above the particular pressure; and
the sequenced accumulator assembly is discharged in a discharge sequence in which the first accumulator of the two or more accumulators is discharged to a particular pressure, and when pressure is reduced and equilibrium between the first and the second accumulator is reached, both the first and the second accumulators are discharged simultaneously.

14. The hydraulic hybrid system of claim 12, wherein:
the two or more accumulators are individually hydraulically isolated and individually hydraulically coupled via the one or more sequence valves and the one or more check valves;
inclusion of the second accumulator increases a storage volume of the sequenced accumulator assembly;
the one or more sequence valves and the one or more check valves are controlled by one or more operating conditions of the hydraulic hybrid system, feedback from the hydraulic hybrid system, conditions in the two or more accumulators, or some combination thereof; and
the two or more accumulators have different volumes.

15. The hydraulic hybrid system of claim 12, wherein:
the sequenced accumulator assembly includes a reverse free flow check valve that is positioned between a first accumulator of the sequenced accumulator assembly and a second and a third accumulators of the sequenced accumulator assembly, and
when pressures in the second and the third accumulators are substantially equal to or greater than a pressure in the first accumulator, the reverse free flow check valve opens which allows pressure to flow between the second and the third accumulators and the first accumulator.

16. The hydraulic hybrid system of claim 12, wherein:
the sequenced accumulator assembly includes a dump valve;
when the dump valve is open, the dump valve dumps pressure on a pilot side of the one or more sequence valves such that a pressure at a first port of the one or more sequence valves passes through the one or more sequence valves without a throttle or sequence operation; and
the dump valve is configured to disable the one or more sequence valves by opening the one or more sequence valves and charges the two or more accumulators simultaneously.

17. The hydraulic hybrid system of claim 12, wherein:
the sequenced accumulator assembly includes a reverse free flow check valve; and
each of the one or more sequence valves includes:
a first port that is fluidly coupled to the hydraulic pump/motor, to a first accumulator of the sequenced accumulator assembly such that as the hydraulic pump/motor is mechanically driven pressure builds at the first port pressure in the first accumulator builds, and to the reverse free flow check valve;
a second port that is fluidly coupled to a second accumulator of the sequenced accumulator assembly and a third accumulator of the sequenced accumulator assembly;
a valve bottom that is configured such that when pressure is ported to the valve bottom, the pressure opens the sequence valve; and
internal porting that allows throttling between the first port and the second port to be stable.

18. The hydraulic hybrid system of claim 17, wherein each of the one or more sequence valves includes a vent that enables a particular pressure at the first port to be set and that allows the pressure at the first port and a first accumulator to be held substantially constant regardless of the pressure at the second port is separated from the second port and vents to the reservoir.

19. The hydraulic hybrid system of claim 12, wherein the sequence valve is configured to sequence filling of a second accumulator and a third accumulator smoothly, such that the second accumulator and the third accumulator fill with no vibration.

20. The hydraulic hybrid system of claim 12, wherein:
the hydraulic system includes a valve assembly and a shuttle valve that is fluidly coupled to the hydraulic pump/motor, the sequenced accumulator assembly, and the valve assembly;
the shuttle valve is configurable in a first configuration in which pressure is supplied to the valve assembly from the hydraulic pump/motor and pressure is prevented from being supplied from the sequenced accumulator assembly; and
the shuttle valve is configurable in a second configuration in which pressure is supplied to the valve assembly from the sequenced accumulator assembly and pressure is prevented from being supplied from the hydraulic pump/motor.
